(19) United States
(12) Patent Application Publication
(10) Pub. No.: US 2026/0149399 A1
(43) Pub. Date: May 28, 2026

(54) MOTOR CONTROL DEVICE, MOTOR CONTROL METHOD, AND STORAGE MEDIUM

(71) Applicant: CANON KABUSHIKI KAISHA, Tokyo (JP)

(72) Inventor: DAISUKE ISHIKAWA, Kanagawa (JP)

(21) Appl. No.: 19/178,195

(22) Filed: Apr. 14, 2025

(30) Foreign Application Priority Data
May 15, 2024 (JP) 2024-079254

(51) Int. Cl. H02P 23/14

(52) U.S. Cl. CPC H02P 23/14

(57) ABSTRACT

A motor control device has an encoder configured to generate a position detection counter value indicating position information for a member that has been connected to a motor, a target position setting unit configured to generate a target position counter value that becomes a movement target for the member that has been connected to the motor; and a control unit configured to calculate an offset value based on the position detection counter value and the target position counter value, generate an offset position counter value by adding the offset value to the position detection counter value, and controlling the motor based on the offset position counter value and the target position counter value.

### BACKGROUND OF THE INVENTION

### Field of the Invention

The present invention relates to a motor control device, a motor control method a storage medium, and the like.

### Description of the Related Art

A method has been proposed in which a motor is provided with a sensor that detects a rotation phase, wherein an advance angle of a drive waveform is controlled in relation to a rotation phase from the rotation phase for the motor that is obtained from the sensor, and the motor is efficiently driven. According to this method, by performing control such that an optimal advance angle is achieved, it becomes possible to rotatably drive the motor more efficiently by inhibiting unnecessary torque, and acceleration as well as reductions in vibrations can be planned.

In addition, Japanese Unexamined Patent Application, First Publication No. 2014-039427 proposes a method of switching between a method for controlling a target advance angle, and a method for controlling a voltage by fixing the advance angle, wherein the switching is performed according to a deviation between a target position and an actual position. Japanese Unexamined Patent Application, First Publication No. 2008-312298 proposes a technology in which, in a case in which an output duty of a PWM for applying a voltage to a motor has reached an upper limit, an advance angle signal corresponding to a deviation between a target speed and a current speed is generated.

In addition, during the motor control, there is a speed control with the goal of stably moving a movable member that has been connected to the motor at a target speed, and a fixed-type position control with the goal of rapidly moving a movable member that has been connected to the motor to a target position. Furthermore, there is a tracking type position control in which the movable member is moved by being tracked to a target position, during which movement is performed at an arbitrary speed.

However, in a case in which a position control is performed that tracks the movable member to a target position that changes constantly, there are cases in which the target position cannot be accurately traced due to undershooting and overshooting caused by the acceleration and deceleration of the motor.

If such a state occurs, when stopping the motor, it is no longer possible to precisely stop at the target position, and excessive settling operations become necessary. In a case in which the above-described technology has been applied to a position control for a variable magnification lens of an image capturing apparatus in particular, an operation to return the variable magnification lens that has gone too far in relation to the target position due to an overshoot becomes necessary, and this causes unnatural changes to the angle of view. Furthermore, there are also cases in which noises caused by overshooting occur when the motor is stopped.

### SUMMARY OF THE INVENTION

A motor control device comprises:
an encoder configured to generate a position detection counter value indicating position information for a member that has been connected to a motor;
a target position setting unit configured to generate a target position counter value that becomes a movement target for the member that is connected to the motor; and
a control unit configured to calculate an offset value based on the position detection counter value and the target position counter value, generate an offset position counter value in which the offset value has been added to the position detection counter value, and control the motor based on the offset position counter value and the target position counter value.

Further features of the present invention will become apparent from the following description of embodiments with reference to the attached drawings.

### BRIEF DESCRIPTION OF THE DRAWINGS

FIG. 1A, is a diagram showing a schematic configurational example of an image capturing lens in a First Embodiment of the present invention, and FIG. 1 B is a diagram showing a locus of a focus lens of the First Embodiment of the present invention.

FIGS. 2 A, and 2B are diagrams showing a schematic configurational example of a motor unit in the First Embodiment of the present invention.

FIG. 3 is a functional block diagram showing a configurational example of a lens control system in a First Embodiment of the present invention.

FIG. 4 is a diagrams showing processing examples for (A) to (E) of an encoder 305 in the First Embodiment.

FIG. 5 is a diagram showing an example of a relationship between advance angle and the rotation speed of a motor.

FIG. 6 is a diagram showing a flow for the processing for (A) to (C), and (E) to (I) of an advance angle control unit 308 and a drive waveform generating unit 309 in the First Embodiment.

FIG. 7A is a diagram showing a state in which the drive counter value has deviated from the target position counter value.

FIG. 7 B is a diagram showing a state in which a deviation has occurred between a target speed (the slope of the target position counter value 7-b-1) and an actual speed (the slope of the position detection counter value 7-b-2).

FIG. 7 C is a diagram explaining position control by power rate correction according to the First Embodiment.

FIG. 8 is a functional block diagram showing a configurational example of the advance angle control unit 308 according to the First Embodiment.

FIG. 9 is a flowchart showing a processing example for the advance angle control unit 308 according to the First Embodiment.

FIG. 10 is a diagram explaining a processing example for the advance angle control unit 308 according to the First Embodiment.

FIG. 11 is a flowchart showing a processing example for a power rate calculating unit 802 according to the First Embodiment

FIG. 12 is a flowchart showing a processing example for the power rate calculating unit 802 according to a Second Embodiment.

FIG. 13 is a diagram explaining a selection of a setting power rate that is realized during step S1204.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate descriptions will be omitted or simplified.

### First Embodiment

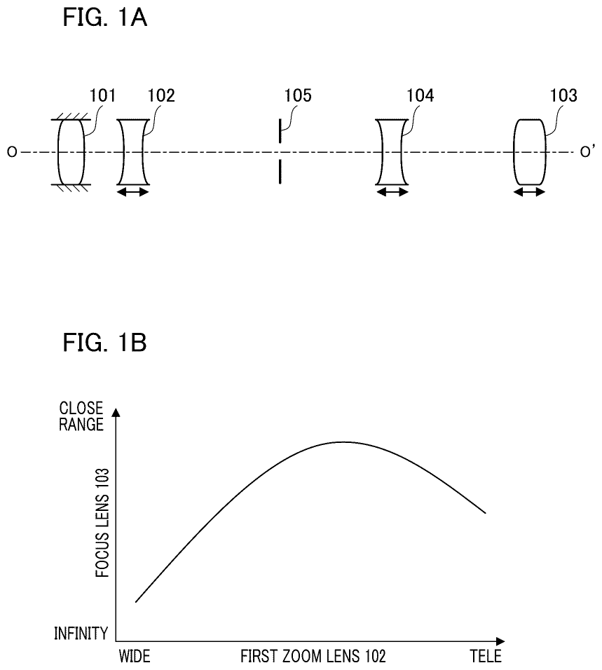

FIG. 1A, is a diagram showing a schematic configurational example of an image capturing lens in a First Embodiment of the present invention, and FIG. 1 B is a diagram showing a locus of a focus lens of the First Embodiment of the present invention. The image capturing lens is configured by a fixed lens 101, a first zoom lens 102, a focus lens 103, a second zoom lens 104, an aperture 105, and the like, and variable magnification is performed by the joint operation of a plurality of lenses using positional relationships that have been determined in advance.

The first zoom lens 102 performs zooming by moving in the optical axis direction (a direction along O-O′). The focus lens 103 is provided with both a function that corrects movement of a focal point surface due to zooming, and a focusing function, and the focus lens 103 is in joint operation with the movement of the first zoom lens 102, and, for example, as is shown in FIG. 1 (B), moves in the direction of the optical axis by following a locus that has been determined in advance.

In this manner, the image capturing lens has at least one zoom lens, and a focusing lens. In addition, the target position counter value for the at least one zoom lens is generated such that the zoom lens moves at the target speed, and the target position counter value for the focus lens is generated such that the focus lens moves by following a locus that has been determined in advance in joint operation with the movement of the zoom lens.

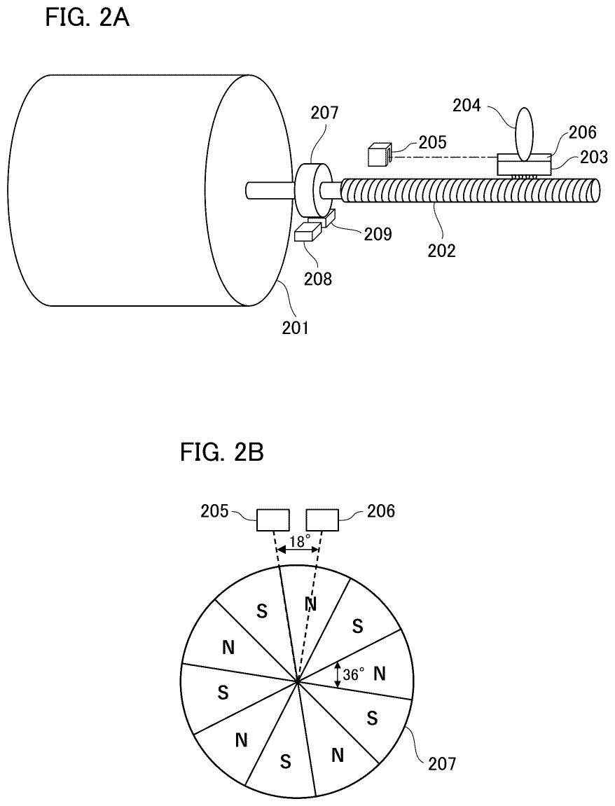

Next, FIGS. 2 A, and B are diagrams showing examples of schematic configurations of the motor unit in the First Embodiment of the present application. Note that each setting for the present motor unit is set in each lens, and the present motor operates independently. That is, a plurality of motors is configured so as to drive each of the lenses that configure the image capturing lens.

In FIG. 2A, the numeral 201 is a stepping motor, the numeral 202 is a rotation axis of the stepping motor 201, and the numeral 203 is a rack. The rotation axis 202 is a lead screw, and a lens 204 that has been connected to the rack 203 moves in the direction of the optical axis according to the rotation of the rotation axis 202 while engaging with the rack 203.

The reference position for the lens is determined by the configuration of a PI (photo interpreter) 205 that has been disposed on top of a fixing member, which is not shown, and a light shielding plate 206 that has been provided on the lens. The PI 205 is configured by a light emitting unit and a light receiving unit, and when the light shielding plate 206 enters between this light emitting unit and light receiving unit in accordance with the movement of the lens 204, a detection signal of the PI 205 switches from high to low.

This switching position is set as the reference position for the lens. The numeral 207 is a cylindrically shaped rotation phase detection magnet that has been attached to the rotation axis 202, and detects the rotation phase of the stepping motor 201 in combination with a rotation phase detecting hall sensor 208 and a rotation phase detecting hall sensor 209. Note that, below, the rotation phase detecting hall sensor 208 is written as Hall-CH0, and the rotation phase detecting Hall sensor 209 is written as Hall-CH1.

FIG. 2B is a diagram explaining the positions of the rotation phase detection magnet 207, the rotation phase detecting hall sensor 208, and the rotation phase detecting hall sensor 209 in a case in which the number of poles for the stepping motor 201 is 10 poles. The rotation phase detection magnet is configured by a magnet having 10 poles so as to match the number of poles of the motor.

Each pole is evenly disposed at a mechanical angle of 36°. The rotation phase detecting hall sensor 208 and the rotation phase detection hall sensor 209 are disposed on an extension of the rotation phase detecting magnet with a mechanical angle of 18°. Due to this configuration, it is made such that each hall sensor detects two types of sine waves in which the phases deviate from each other by 90° according to the rotation of the motor.

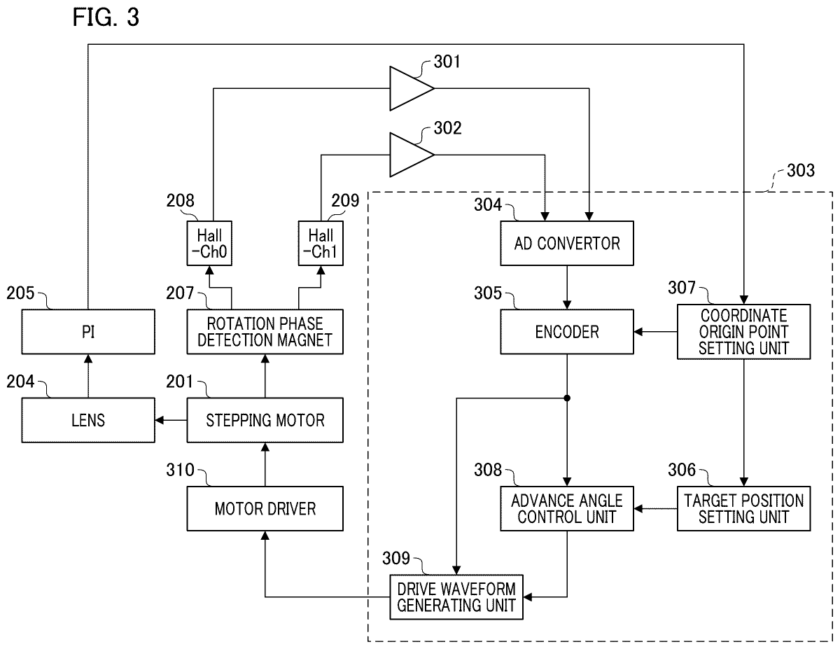

Next, FIG. 3 is a functional block diagram showing a configurational example of a lens control system in the First Embodiment of the present application. Note that the present system is set respectively for each lens, and the processing is performed independently for each lens. Note that a portion of the functional blocks that are shown in FIG. 3 are realized by a CPU and the like that function as a computer, which is not shown, that is included in the lens control system, executing a computer program that has been stored on a memory serving as a storage medium, which is also not shown.

However, a portion or the entirety thereof may also be made so as to be realized by hardware. As this hardware, an application specific integrated circuit (ASIC), and a processor (a reconfigurable processor, a DSP), and the like can be used.

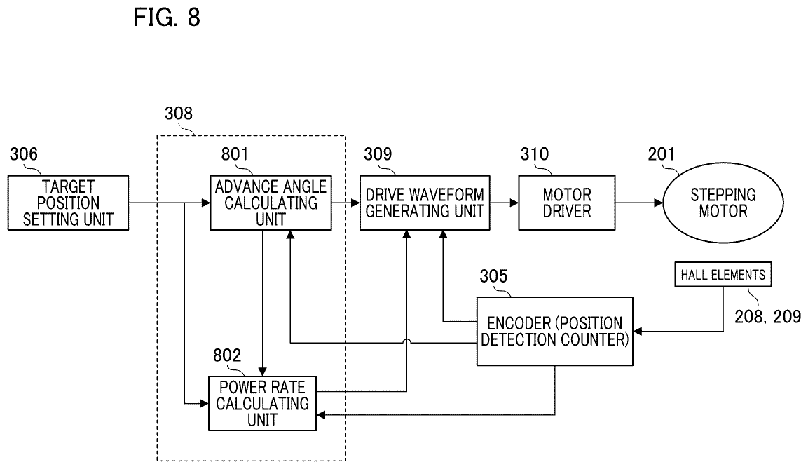

In addition, each of the functional blocks that are shown in FIG. 3 may be housed in the same body, or they may also be configured by separate devices that have been connected to each other via signal paths. Note that the above explanation regarding FIG. 3 also applies in the same manner to FIG. 8.

The blocks in FIG. 3 that have the same numerals as the blocks in FIG. 2 are the same members. The two-phase hall signal that has been detected by the Hall-Ch0 is amplified in an amp circuit 301, and the two-phase hall signal that has been detected by the Hall-Ch1 is amplified in an amp circuit 302. The position detection counter value is calculated by the amplified 2-phase hall signals being quantized in an AD converter 304 of a motor control device 303 then encoded by the encoder 305.

That is, the encoder 305 generates a position detection counter value that indicates the position information for the lens 204, which serves as a member that has been connected to the motor.

The numeral 306 is a target position setting unit that sets a target position for the lens, and the target position setting unit 306 generates a target position counter value for controlling each lens at the target speed to the target position thereof. That is, the target position setting unit 306 for the lens control system that has been connected to the first zoom lens 102 generates the target position counter value such that this becomes the target zoom speed. In this manner, the target position setting unit 306 generates the target position counter value such that it becomes the movement target for the drive member that has been connected to the motor.

In addition, the target position setting unit 306 of the lens control system that has been connected to the focus lens 103 generates the target position counter value such that, as was shown in the example in FIG. 1B, the focus lens 103 moves in joint operation with the movements of the first zoom lens 102 by following a locus that has been determined in advance. In addition, in the same manner, the target position counter value is generated such that the second zoom lens 104 also moves in joint operation with the movement of the first zoom lens 102 by following a locus that has been determined in advance.

The target position counter value and the position detection counter value are set at the same coordinate origin points in a coordinate origin point setting unit 307, and the coordinates match. The numeral 308 is the advance angle control unit, and in this context, the control of the advance angle and the power rate is performed in the advance angle control unit 308 in order to drive the motor by following the target position.

The numeral 309 is the drive waveform generating unit, and the drive waveform generating unit 309 generates a drive counter value by adding the target advance angle to the position detection counter value to serve as the offset value, performs SIN/COS conversion on the drive counter value that has been generated, and generates a two-phase drive waveform in which the amplitude has been further adjusted according to the power rate.

In this context, the advance angle control unit 308 and the drive waveform generating unit 309 function as a control unit configured to control a rotation speed and a rotation position of the motor based on the target advance angle. In addition, the control unit controls at least one of a target advance angle and a drive voltage (power rate) that are set in the motor.

However, feedback control cannot be performed until the coordinate origin point is set in the coordinate origin point setting unit 307, and therefore, open control is performed. That is, the advance angle control unit 308 sets the target position counter value that is obtained from the target position setting unit 306 as the drive counter value, and also open controls the drive waveform by setting the power rate for use during the open control.

The drive waveform that has been generated by the drive waveform generating unit 309 is supplied to a motor driver 310 as, for example, a PWM signal, and is converted into a motor drive signal in the motor driver 310 and then supplied to the stepping motor 201. Note that the drive waveform may also be supplied to the motor drive 310 after AD conversion processing, or the drive waveform may also be supplied as drive waveform information from a communications port.

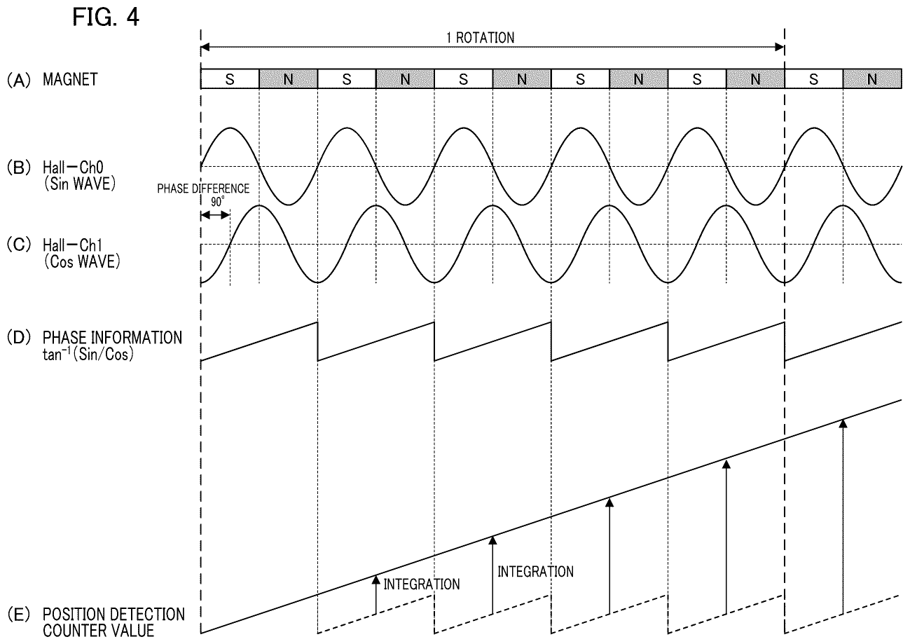

In this context, a detailed explanation of the processing for the encoder 305 will be given using FIG. 4. FIG. 4 is a diagram showing the processing examples for (A) to (E) of the encoder 305. Note that, in this context, an example is explained of a configuration that matches the configuration in FIG. 2 (B), wherein the number of poles for the stepping motor 201 is made 10 poles, and the rotation phase detection magnet 207 is also made a cylindrical magnet with a pole number of 10 poles.

In FIG. 4, (A) shows the rotation phase detection magnet 207 of the motor, while (B) shows the waveform for the hall signal that is detected by the Hall-CH0, and (C) shows the waveform for the hall signal that is detected by the Hall-Ch1. According to the configuration that is shown in FIG. 2 (B), a sine wave (Sin wave) and a cosine wave (Cos wave) for which the phases deviate from one another by 90° are obtained as the hall signals.

The encoder 305 performs an arctangent computation (tan−1 (Sin/Cos)) using (B), and (C), which are the signals for the Sin wave and Cos wave that have been quantized in the AD converter 304, and calculates the phase information from 0 to 360°.

(D) shows the phase information that has been calculated, and integration processing is performed on this calculated phase information, and a phase detection counter value (E) that shows the motor rotation amount is calculated. It is possible to convert this rotation amount information to position information for the lens by multiplying this rotation amount by a screw pitch of the lead screw.

Therefore, rotation amount information for the motor that has been calculated by the encoder 305 is treated as a position detection counter value for the lens. That is, the encoder 305 functions as an encoding unit configured to execute an encoding step that detects a rotation state of the motor then converts this into actual position information. Note that although in this context, the phase information has been explained as being information from 0 to 360°, this is determined by the resolution of the position detection counter value, and is not limited thereto.

Next, a detailed explanation will be given in relation to the processing for the coordinate origin point setting unit. The motor control device 303 first executes a setting sequence for the coordinate origin point for the lens when power is supplied thereto.

That is, the lens is driven, the lens position at which the detection signal for the PI 205 that was explained in FIG. 2 will switch from High to Low is searched for, this switching point that has been searched for is made the coordinate origin point, and the position detection counter value and the target position counter value are reset to a predetermined value. It thereby becomes possible to make the coordinates for both match, and to perform control for the lens positions.

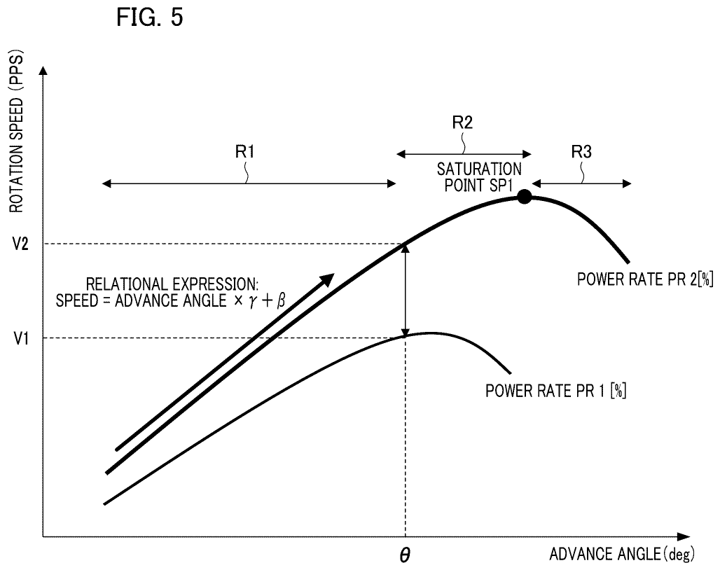

FIG. 5 is a diagram showing an example of the relationship between the advance angle and the motor rotation speed in the First Embodiment, and FIG. 5 shows an example in which the relationship between the advance angle and the motor rotation speed is power rate PR 1%, and PR 2% (PR1<PR2). Note that PR1% is, for example, 50%, and PR2% is, for example, 60%. The amplitude of the drive waveform for the power rate is adjusted, and for example, when the power rate is 60%, a waveform is generated such that the amplitude of the drive waveform is restrained to 60%.

In FIG. 5, it can be understood that in the region R1, the motor rotation speed increases proportionately as the advance angle becomes larger. However, if the advance angle is further increased, the region R2 will eventually be reached, where rises in the motor rotation speed in relation to the advance angle gradually become saturated. If the advance angle is further increased and a saturation point SP1 is passed, the region R3 will be entered, where the motor rotation speed will begin to fall.

In addition, the larger that the power rate is, the steeper the slope of the advance angle vs the motor rotation speed in the region R1 will become, and in addition, the saturation point SP1 will shift into a larger advance angle. The relationship between the advance angle and the speed is a proportional relationship within the range of the region R1. That is, the relationship between the advance angle and the speed can be expressed using the following Formula (1).

$$Speed = advance angle \times γ + β \qquad Formula ( 1 )$$

Wherein γ is the slope and β is the intercept.

In this context, the relationship between the advance angle and the rotation speed is measured in advance, and the region R1, which is the valid region for the Formula (1) corresponding to the slope γ, the intercept β, and the region R1 of the Formula (1), is stored as an advance angle vs speed table based on the measurement data.

Note that a plurality of advance angle vs speed tables are stored for each power rate, and it is made possible to select a table according to the target speed. In addition, it is made such that a smaller power rate is preferentially selected. Note that although in the present context, the relationship between the advance angle and the speed has been explained as the Formula (1), the rotation speed of the motor and the corresponding information for the advance angle may also be a data table in which the relationship between this advance angle and speed has been stored in advance.

Note that the larger the power rate becomes, the larger the rotation speed for the motor becomes. For example, it is assumed that the advance angle is set to a specific advance angle θ, and the motor is made to rotate at the power rates PR 1%, and PR2%. In this case, if the corresponding rotation speeds for the motor are made V1 and V2 respectively, then V1<V2. That is, it is possible to change the rotation speed of the motor by controlling the size of the power rate.

In order to change the number of rotations for the motor, the advance angle control according to the First Embodiment has a processing PS that changes the motor rotation speed based on the Formula (1) by changing the advance angle, a processing P2 that changes the motor rotation speed by changing the power rate, and a processing P3 that uses both the processing P1 and the processing P2.

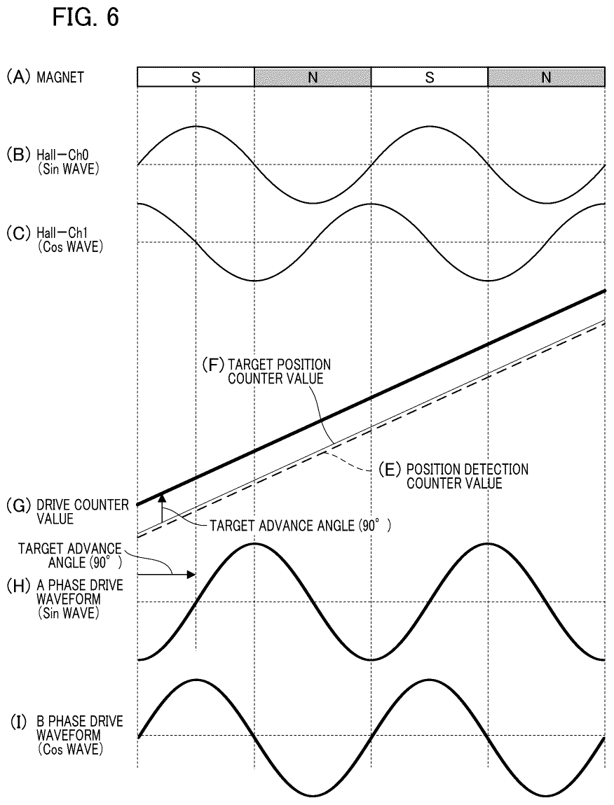

FIG. 6 is a diagram showing processing flows for (A) to (C) and (E) to (I) of the advance angle control unit 308 and the drive wave form generating unit 309 in the First Embodiment. Note that (A), (B), (C), and (E) in FIG. 6 are the same as the signals having the same reference numerals in FIG. 4, and therefore explanations thereof have been omitted. (F) shows a target position counter value. As has been explained above, the target advance angle and the power rate are calculated such that the position detection counter value (E) will reach the target position counter value (F).

Note that below, an explanation is given of an example for a case in which the target advance angle is 90°. The advance angle control unit 308 generates the drive counter value (G) by superimposing the target advance angle of 90° on the position detection counter value (E).

The position detection counter value is a counter value in which the phase information from 0 to 360° has been integrated, and in the same manner, the phase information for the drive counter value (G) also becomes 0 to 360°. Therefore, by performing SIN conversion and COS conversion on this drive counter value (G) in the drive waveform generating unit 309, two phases, an A phase drive waveform (Sin wave) (H), and a B phase drive waveform (Cos wave) (I), for which the phases deviate from each other by just the advance angle amount are generated in relation to the motor rotation phase.

The drive waveform generating unit 309 generates an offset position counter value in which the target advance angle has been added to the position detection counter value as an offset value, and controls the motor based on the offset position counter value and the target position counter value. Note that the offset position counter value is determined based on the position detection counter value and the target advance angle, and the target advance angle is set based on the target position counter value and the position detection counter value.

In addition, these drive waveforms are output to the motor driver 310 by setting the power rate so as to become the target amplitude. Note that in this context, although an example has been explained in which the information for 0 to 360° has been used as the phase information, the phase information is determined by the resolution of the position detection counter value (E), and is not limited thereto.

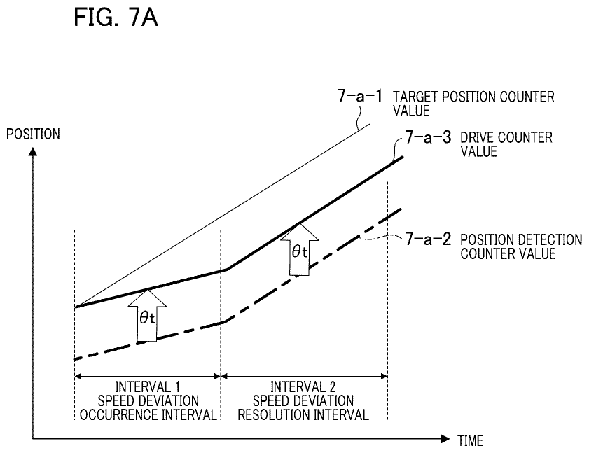

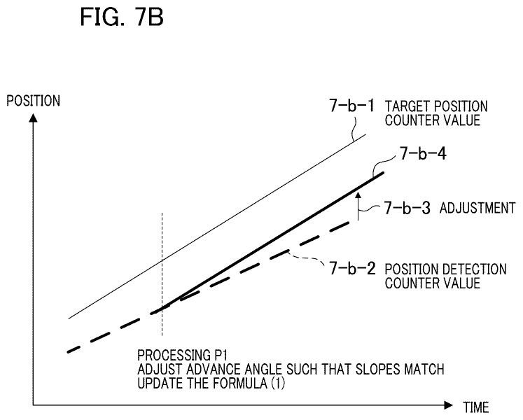

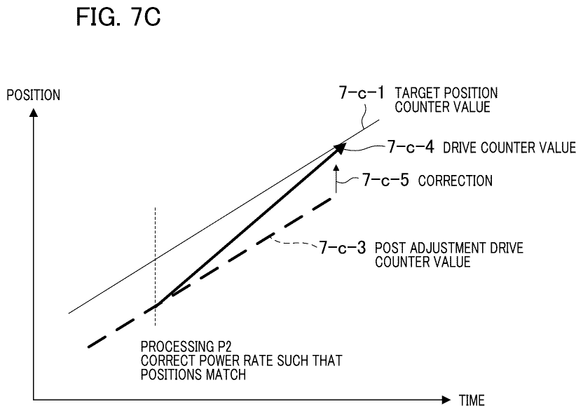

Next, an explanation will be given of the processing for making the position detection counter value reach the drive counter value, which has been advanced by exactly the target advance angle θt in relation to the target position counter value according to the First Embodiment using FIGS. 7A to C.

In the First Embodiment, the advance angle control controls the speed and position by adjusting the advance angle and power rate. In addition, a counter value in which the advance angle of the position detection counter value has been advanced by exactly θt is made the drive counter value. Note that in this context, a case is assumed in which the target advance angle has been set to the fixed value Ot. Note that in this context, the target advance angle θt functions as an offset value that is calculated based on the target detection counter value and the target position counter value.

FIG. 7A is a diagram showing a state in which the drive counter value has deviated from the target position counter value. In FIG. 7A, 7-a-1 is the target position counter value, 7-a-2 is the position detection counter value, and 7-a-3 is a counter value in which the advance angle for the position detection counter value 7-a-2 has been advanced by exactly Ot, and shows the drive counter value.

In the interval 1 of FIG. 7A, a deviation in speed occurs due to interference, load fluctuation, and the like, and a deviation occurs between the target position counter value 7-a-1, and the drive counter value 7-a-3. In the interval 2, the deviation in speed is resolved, however, the deviation between the target position counter value 7-a-2 and the drive counter value 7-a-3 remains.

In this manner, for example, when just adjusting the speed by using only the advance angle control, there are cases in which position control to catch up the target position counter value cannot be realized. In this context, in the First Embodiment, a position control is performed such that the drive counter value 7-a-3 is able to catch up to the target position counter value 7-a-2.

FIG. 7 B is a diagram showing a state in which a deviation has occurred between the target speed (the slope of the target position counter value 7-b-1), and the actual speed (the slope of the position detection counter value 7-b-2). As the preceding processing for the position control, in a case in which, as is shown in FIG. 7B, a deviation has occurred between the target speed (the slope of the target position counter value 7-b-1), and the actual speed (the slope of the position detection counter value 7-b-2), adjustment is performed for the slope of the position detection counter value 7-b-2, as is shown by 7-b-3.

That is, during the processing P1, by adjusting the slope of 7-b-3 by, for example, adjusting the advance angle such that the actual speed matches the target speed, the deviation in speed between the position detection counter value after adjustment and the target speed (the slope of the target position counter value 7-b-1) is resolved as is shown by 7-b-4.

FIG. 7 C is a diagram explaining position control by correcting the power rate according to the First Embodiment. The deviation in positions between the target position counter value 7-c-1 and the drive counter value 7-c-3 is corrected. That is, during the processing P2, the correction of 7-c-5 is realized by further correcting the advance angle so as to make the drive counter value and the target position counter value match, and the deviation in position has been corrected for the drive counter value after correction, as is shown by 7-c-4.

In this manner, in the present embodiment, it is possible to resolve deviations in speed and deviations in position by using the advance angle control and the power rate control.

FIG. 8 is a functional block diagram showing a configurational example of the advance angle control unit 308 according to the present embodiment, and the blocks that have been given the same reference numerals as the blocks in FIG. 3 are the same configurations as those in FIG. 3, and explanations thereof are therefore omitted. The target position counter value that is output from the target position setting unit 306 is transmitted to the advance angle calculating unit 801.

The advance angle calculating unit 801 calculates the necessary advance angle for the drive based on the target position counter value, the position detection counter value from the encoder 305, and the previously described Formula (1), and the advance angle that has been calculated is transmitted to the drive waveform generating unit 809 and the power rate calculating unit 802.

The target position counter value that is output from the target position setting unit 306 is transmitted to the power rate calculating unit 802, and the power rate is calculated in the power rate calculating unit 802 based on the advance angle that has been calculated by the advance angle calculating unit 801, the target position counter value, and the position detection counter value.

The advance angle, which is an output of the advance angle calculating unit 801, and the power rate, which is an output of the power rate calculating unit 802, are transmitted to the drive waveform generating unit 309, the drive waveform that is necessary for the drive of the motor is generated and transmitted to the motor driver 310, and the stepping motor 201 is rotated.

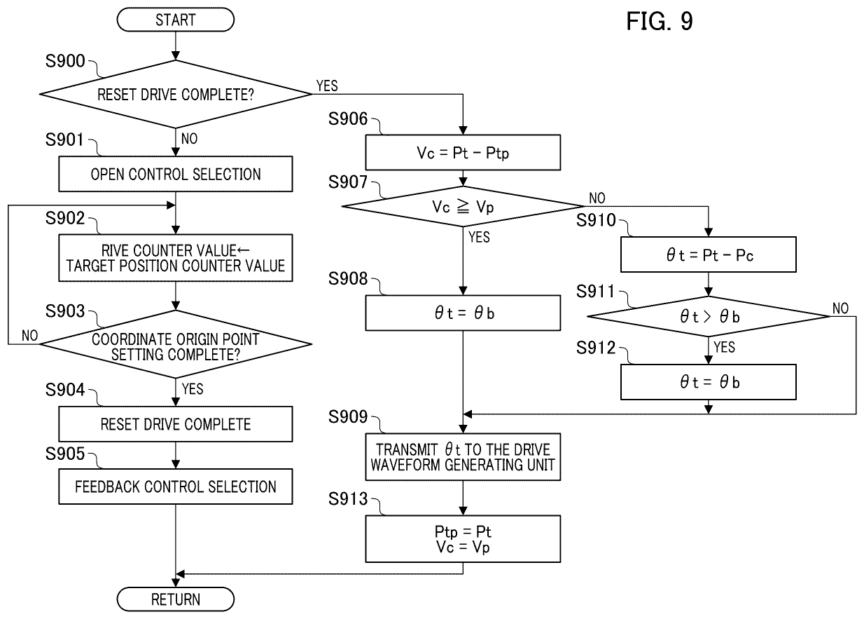

FIG. 9 is a flowchart showing a processing example for the advance angle control unit 308 according to the First Embodiment. Note that the operations for each step of the flowchart in FIG. 9 are performed in order by the CPU and the like that serve as a computer of the motor control device 303 executing a computer program that has been stored on a memory.

During step S900, the advance angle control unit 308 identifies whether or not the reset drive has been completed. In a case in which No has been identified during step S900, the processing proceeds to step S901, and open control is selected. Upon open control being selected, during step S902, the motor is driven by setting the target position counter value as the drive counter value.

During step S903, it is identified whether or not the coordinate origin point setting by the coordinate origin point setting unit 307 has been completed. In a case in which No has been identified during step S903, the processing returns to step S902. That is, during the open control, the reference position is detected in the PI 205, and the reset drive is continued until the same coordinate origin points are set for the position detection counter value and the target position counter value in the coordinate origin point setting unit 307.

Upon a notification being received from the coordinate origin point setting unit 307 that the coordinate origin point setting has been completed, Yes is identified during step S903, and the processing proceeds to step S904. During step S904, a flag or the like is used to set that there is a completion state for the reset drive, and during step S905, advance angle control by feedback control is selected. After this, the processing returns to step S900.

In contrast, upon detecting during step S900 that there is a completion state for the rest drive, Yes is identified, and the processing proceeds to step S906. During step S906, a target position differential Vc for a target position Pt and the last previous target position Ptp is calculated.

Next, during step S907, the size relationship between the target position differential Vc and a last target position differential Vp is compared, and in a case in which Vc is greater than or equal to Vp, the processing proceeds to step S908. Note that step S907 identifies whether or not there is a tendency to increase for the speed.

During step S908, a pre-determined reference advance angle θb is written as the target advance angle θt. That is, the target advance angle θt, which serves as the offset value, is set to θb, which is a predetermined offset value, in a case in which the speed of the motor has increased by an amount that is greater than or equal to a predetermined threshold value.

Note that the reference advance angle θb is assigned to the advance angle for which the torque is relatively high from among the advance angles with the same power rate. That is, in the example that has been shown in FIG. 5, in the case of, for example, the power rate PR2, the torque for the range of the region R2 in which the rotation speed increases is higher than the torques for the region R1 and the region R3, and therefore, it is preferable if the reference advance angle θb is selected from this region R2.

In contrast, during step S907, in a case in which it has been identified that Vc is smaller than the previous target position differential Vp, the processing proceeds to step S910. During step S910, the difference between a target position P1 and a current position Pc is found, and this difference is written as the target advance angle θt.

The value in which the target advance angle θt has been added to the current position Pc thereby becomes such that it matches the target position Pt. Note that in the present embodiment, the target advance angle θt that serves as the offset value is set according to the difference between the position detection counter value and the target position counter value.

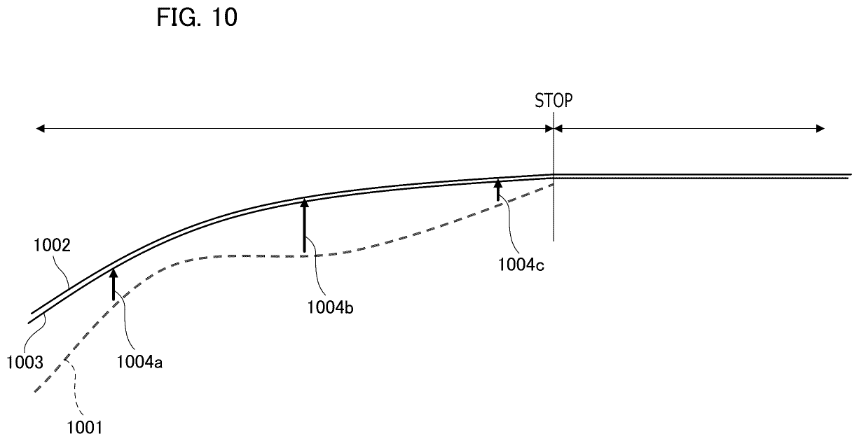

FIG. 10 is a diagram explaining a processing example for the advance angle control unit 308 according to the First Embodiment, and shows each positional relationship that occurs during the processing for step S910. The reference numeral 10001 shows the current position Pc, and the reference numeral 1002 shows the target position Pt, which is a constantly changing position.

In addition, the reference numeral 1003 shows the position (=Pc+θt) in which the target advance angle θt has been added to the current position Pc. The reference numeral 1004a shows the target advance angle θt, and the processing that generates the target advance angle θt 1004b, and 1004c for each set of processing is repeated. Note that if the target position is reached, the drive stops, and position control is performed by returning to the actual position.

Next, during step S911, it is identified whether or not the target advance angle θt that was set during step S910 is larger than the reference advance angle θb, and in a case in which it has been identified that the target advance angle θt is equal to or less than the reference advance angle θb, the processing proceeds to step S909. During step S911, in a case in which it has been identified that the target advance angle θt is larger than the reference advance angle θb, the processing proceeds to step S912, and the reference advance angle θb is set as the targe advance angle θt.

That is, if the advance angle θ becomes too large, as is shown in FIG. 5, the region R3 in which the torque rapidly drops will be approached, and therefore processing is executed in which a limit is applied using Ob. After this, the processing proceeds to step S909.

In this manner, in the First Embodiment, in a case in which the difference between a position detection counter value and a target position counter value is larger than a predetermined value (θb), the advance angle, which serves as the offset value, is set to Ob, which is a predetermined offset value. Note that although in the present embodiment, the value that is used as a comparison during step S911 and the value that is set as the offset value during step S911 are the same value, these may also be different values.

In addition, the target advance angle θt may also be made zero directly before stopping in FIG. 10. It is thereby possible to inhibit reversal operations (hunting) when the motor is being stopped.

In the present embodiment, by controlling the advance angle as has been described above, it is possible to inhibit the occurrence of overshooting and undershooting, and it is possible to inhibit strange noises, as well as reversal operations and unnatural changes to the angle of view when the motor is stopped.

During step S909, the target advance angle θt is transmitted to the drive waveform generating unit 309. An offset position counter value in which the target advance angle θt has been added to the position detection counter value as an offset value is generated, and the motor is controlled based on the offset position counter value and the target position counter value in the drive waveform generating unit 309.

During step S913, in order to prepare for the next processing, the target position Pt is set as the previous target position Ptp, the target position differential Vc is set as the previous target position differential Vp, these are stored, and after this, the processing returns to step S900.

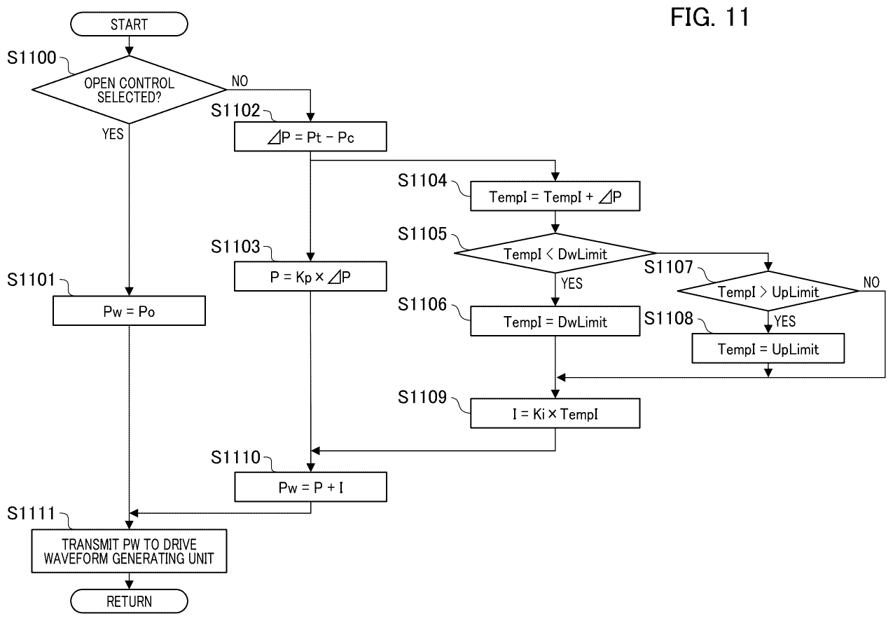

FIG. 11 is a flowchart showing a processing example for the power rate calculating unit 802 according to the First Embodiment. Note that the operations for each step of the flowchart in FIG. 11 are performed in order by the CPU and the like that serve as the computer of the motor control device 303 executing a computer program that has been stored on a memory.

First, during step S1100, it is identified whether or not open control has been selected. The open control state is selected during the previously explained step S901 of FIG. 10 of the advance angle control unit 308, and the feedback control state is selected during step S905. In a case in which open control has been identified, the processing proceeds to step S1101, and the necessary power rate Po for the motor rotation in open control is set as the target power rate Pw. After this, the processing proceeds to step S1111.

In contrast, in a case in which it has been identified during step S1100 that the control is not the open control, that is, when feedback control has been identified, the processing proceeds to step S1102. During step S1102, a position deviation ΔP, which is the difference between the target position Pt and the current position Pc, is calculated, and the processing after this branches into step S1103, and step S1004, which are performed parallelly.

During step S1103, proportional control processing is performed, a constant of proportionality Kp and the position deviation ΔP are multiplied, and substituted for the variable P.

In contrast, during step S1104 to step S1109, the processing for integral control is performed. First, during step S1104, the position deviation ΔP is added to an intermediate variable TempI, and this is substituted for the intermediate variable TempI again.

During step S1105, it is identified whether or not the intermediate variable TempI is smaller than an integral limit lower limit value DwLimit, and in the case of Yes during step S1105, the processing proceeds to step S1106, and the integral limit lower limit value DwLimit is substituted for the intermediate variable TempI.

In contrast, during step S1105, in a case in which the intermediate variable TempI is larger than the integral limit lower limit value DwLimit, the processing proceeds to step S1007, and it is identified whether or not the intermediate variable TempI is larger than an integral limit upper limit value UpLimit. In a case in which No has been identified during step S1007, the processing proceeds to step S1109, and in a case in which Yes has been identified during step S1107, the processing proceeds to step S1108.

During step S1108, the integral limit upper limit value UpLimit is substituted for the intermediate variable TempI, and the processing proceeds to step S1109. During step S1109, the intermediate variable TempI is multiplied by an integral constant Ki and substituted for the variable I. During step S1110, the target power rate Pw is set by adding the variable P that was set during step S1103 and the variable I that was set during step S1109. After this, the processing proceeds to step S1111.

Note that in the present embodiment, a P1 control (proportional-integral controller) is applied that uses a proportional control and an integral control. However, this may also be realized as a PID (proportional-integral-derivative controller) by further adding a derivative element thereto.

That is, the position deviation correction may also be set based on the results of processing using at least one of proportional, differential, or integral calculations of the deviation amount between the position detection counter value and the target position counter value.

In addition, the same control characteristics may also be realized by combining a high pass filter and a low pass filter instead of the processing for step S1102 to step S1110. That is, the position deviation correction amount may also be set based on the results of processing that uses a low pass filter or a high pass filter on the deviation amount for the position detection counter value and the target position counter value.

During step S1111, the processing returns to step S1110 after the target power rate Pw is transmitted to the drive waveform generating unit 309, and the processing for the flow in FIG. 11 is repeated.

### Second Embodiment

Next, the Second Embodiment of the present disclosure will be explained. Note that in the Second Embodiment, what differs from the First Embodiment is the portion of the processing for the power rate calculating unit 802, and therefore, explanations of the other portions will be omitted. In the Second Embodiment, during the performance of the advance angle control, the power rate is raised such that the speed does not decrease in a case in which the advance angle has decreased. It is thereby made such that the speed can be maintained.

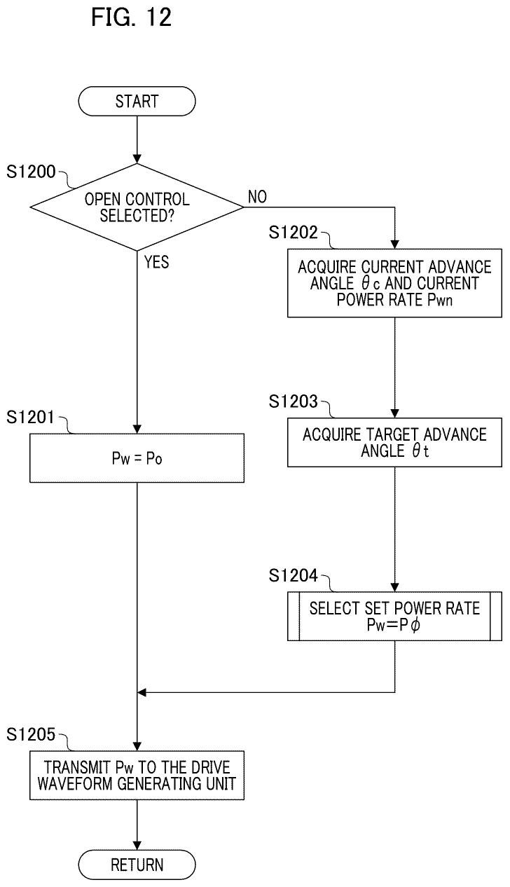

FIG. 12 is a flowchart showing aa processing example for the power rate calculating unit 802 according to the Second Embodiment. Note that the operations for each step of the flowchart in FIG. 12 are performed in order by the CPU and the like that serve as a computer of the motor control device 303 executing a computer program that has been stored on a memory.

First, during step S1200, whether or not there is an open control state is identified. The open control state is determined by the previously described processing for the flowchart that is shown in FIG. 10 for the advance angle control unit. In a case in which open control has been identified, the processing proceeds to step S1201, and the power rate Po that is necessary for the motor rotation during open control is set as the target power rate Pw.

In contrast, in a case in which it has been identified that there is not an open control state during step S1200, the processing proceeds to step S1202, and the currently set advance angle θc and the currently set power rate Pwn are acquired. After this, the processing proceeds to step S1203, the target advance angle θt that has been set by the advance angle calculating unit 801 during the flow for FIG. 9 is acquired, and after this, the processing proceeds to step S1204 and the set power rate is selected.

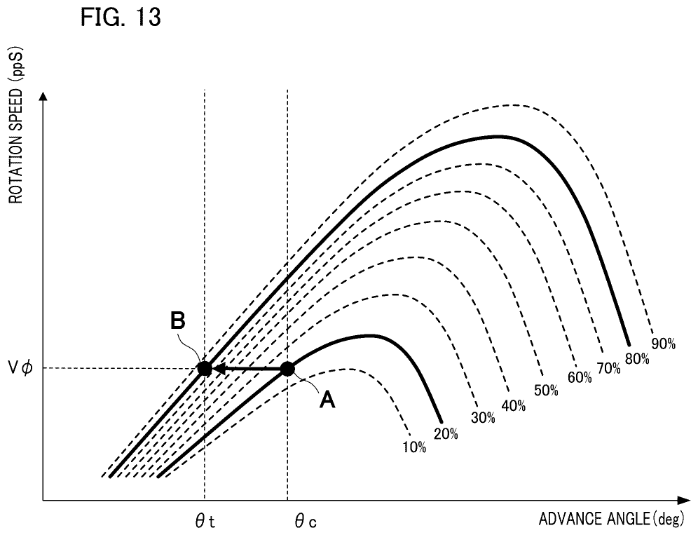

FIG. 13 is a diagram for explaining the selection of the set power rate that is executed during step S1204. FIG. 13 shows the characteristics of the advance angle and the rotation speed (vertical axis: rotation speed, horizontal axis: advance angle) for each power rate from 10% to 90%, and the characteristic data that is shown in FIG. 13 is stored as a functional equation or a table in the power rate calculating unit 802.

In addition, the drive voltage (power rate) is controlled based on characteristic data such as FIG. 13, which shows the relationship between the target advance angle, the motor speed, and the drive voltage (power rate).

In this context, a case is assumed in which the current power rate Pwn is 20% in relation to the current advance angle θc. According to FIG. 13, it is possible to acquire a rotation speed Vφ at a point A on a graph, where a curve showing the power rate Pwn=20% intersects with the current advance angle θc. In contrast, the curve that represents the power rate that passes through the point B, which is the rotation speed Vφ at the time of the target advance angle θt, becomes 80%.

That is, in a case in which the advance angle has changed from the current advance angle θc to the target advance angle θt, the current power rate Ptc=20%, and therefore, it is understood that if the set power rate Pφ is made 80%, the rotation speed Vφ can be maintained. The state is made the above-describe state, and during step S1204, the set power rate Pφ is acquired, and set as the target power rate Pw.

Next, during step S1205, the target power rate Pw is transmitted to the drive waveform generating unit 309, after which the processing returns to step S1200, and the processing for the flow for FIG. 12 is repeated.

Above, an embodiment has been explained in which an advance angle control is used to realize a position control in which a target position counter value that moves at an arbitrary speed is reached, and for example, an image capturing lens is moved. According to the advance angle control of the above-described embodiment, it is possible to efficiently rotation drive a motor, and it is possible to realize a tracking-type position control that has a high responsivity and a low vibration effect.

Note that although in the above-described embodiments, the motor was used to drive a lens, the driven member, which is the drive target, is not limited to being a lens, and may also be any kind of article.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the motor control device and the like through a network or various storage media. Then, a computer (or a CPU, an MPU, or the like) of the motor control device and the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-079254, filed on May 15, 2024, which is hereby incorporated by reference herein in its entirety.

What is claimed is:

1. A motor control device comprising at least one processor or circuit configured to function as:
an encoder configured to generate a position detection counter value indicating position information for a member that has been connected to a motor
a target position setting unit configured to generate a target position counter value that becomes a movement target for the member that has been connected to the motor; and
a control unit configured to calculate an offset value based on the position detection counter value and the target position counter value, to generate an offset position counter value in which the offset value has been added to the position detection counter value, and control the motor based on the offset position counter value and the target position counter value.

2. The motor control device according to claim 1, wherein the control unit controls at least one of a target advance angle and a drive voltage that are set in the motor.

3. The motor control device according to claim 2, wherein the offset position counter value is determined based on the position detection counter value and the target advance angle.

4. The motor control device according to claim 2, wherein the control unit sets the target advance angle based on the target position counter value and the position detection counter value.

5. The motor control device according to claim 2, wherein the control unit controls the drive voltage based on characteristic data indicating the relationship between the target advance angle, a speed of the motor, and the drive voltage.

6. The motor control device according to claim 1, wherein the control unit sets a position deviation correction amount based on a result of processing in which a low pass filter or a high pass filter is used on a deviation amount for the position detection counter value and the target position counter value.

7. The motor control device according to claim 1, wherein the control unit sets a position deviation correction amount based on results of processing using at least one of proportional, differential, or integral calculations of a deviation amount for the position detection counter value and the target position counter value.

8. The motor control device according to claim 1, wherein the offset value is an advance angle that is set according to a difference between the position detection counter value and the target position counter value.

9. The motor control device according to claim 1, wherein the offset value is set as a predetermined offset value in a case in which a difference between the position detection counter value and the target position counter value is larger than a predetermined value.

10. The motor control device according to claim 1, wherein the offset value is set as a predetermined offset value in a case in which a speed of the motor has increased by a predetermined threshold value or more.

11. A motor control method configured to:
calculate a position detection counter value indicating position information for a member that has been connected to a motor;
calculate a target position counter value that becomes a movement target for the member that has been connected to the motor; and
calculate an offset value based on the position detection counter value and the target position counter value, generate an offset position counter value in which the offset value has been added to the position detection counter value, and control the motor based on the offset position counter value and the target position counter value.

12. A non-transitory computer-readable storage medium configured to store a computer program comprising instructions for executing following processes:
calculate a position detection counter value indicating position information for a member that has been connected to a motor;
calculate a target position counter value that becomes a movement target for the member that has been connected to the motor; and
calculate an offset value based on the position detection counter value and the target position counter value, generate an offset position counter value in which the offset value has been added to the position detection counter value, and control the motor based on the offset position counter value and the target position counter value.
